(19) United States
(12) Patent Application Publication
(10) Pub. No.: US 2024/0081575 A1
(43) Pub. Date: Mar. 14, 2024

(54) COFFEE MAKER DRIP STOP MECHANISM

(71) Applicant: Helen of Troy Limited, St. Michael (BB)

(72) Inventors: Martin Mutch, Bend, OR (US); Kristopher Blake Wagner, Brooklyn, NY (US)

(21) Appl. No.: 18/242,088

(22) Filed: Sep. 5, 2023

Related U.S. Application Data
(60) Provisional application No. 63/405,573, filed on Sep. 12, 2022.

(51) Int. Cl. A47J 31/06; A47J 31/10; A47J 31/44

(52) U.S. Cl. CPC A47J 31/0605; A47J 31/10; A47J 31/4467

(57) ABSTRACT

A coffee maker includes a frame, and a brew basket slidably mounted to the frame. The brew basket includes a beverage outlet. A drip stop mechanism operatively associated with the brew basket includes a slider slidably mounted to an underside of the brew basket and a catch member mounted on the frame. The slider is adapted to move from a sealed, closed position where the beverage outlet is closed by the slider toward a brew, open position where the beverage outlet is open as the brew basket is being mounted on the frame. The slider is adapted to move from the open position toward the closed position as the brew basket is removed from the frame. The catch member is adapted to engage the slider as the brew basket is being mounted on the frame.

The present application claims priority to U.S. Prov. Patent App. Ser. No. 63/405,573, filed Sep. 12, 2022, which is incorporated herein in its entirety.

### BACKGROUND

Hot beverage brewers are well known in art for use in brewing coffee, tea, etc. There are many different types of hot beverage brewers employing various brewing techniques and principles. In some scenarios, water is poured into a separate chamber and coffee grounds are disposed in a paper filter fitted in a filter basket which is located above a container. Thereafter, the water is heated and directed into a funnel from which it drips through the coffee grounds and into the container, thereby making coffee.

### BRIEF DESCRIPTION

According to one aspect of the present disclosure, a coffee maker comprises a frame, and a brew basket slidably mounted to the frame. The brew basket includes a beverage outlet. A drip stop mechanism is operatively associated with the brew basket. The drip stop mechanism includes a slider slidably mounted to an underside of the brew basket. The slider is adapted to move from a sealed, closed position where the beverage outlet is closed by the slider toward a brew, open position where the beverage outlet is open as the brew basket is being mounted on the frame. The slider is adapted to move from the open position toward the closed position as the brew basket is removed from the frame.

According to another aspect of the present disclosure, drip stop mechanism for brew basket of a coffee maker is provided. The coffee maker includes a frame for the brew basket. The drip stop mechanism comprises a slider slidably mounted to an underside of the brew basket, and a catch member pivotably mounted to the frame. The slider is adapted to slide along the underside of the brew basket between a brew, open position with the brew basket mounted on the frame and a sealed, closed position with the brew basket removed from the frame. The catch member is adapted to engage the slider as the brew basket is being mounted on the frame.

### BRIEF DESCRIPTION OF THE DRAWINGS

FIG. 1 is a perspective view of a coffee maker according to the present disclosure.

FIG. 2 is a perspective view of a brew basket mounted on a supporting shelf of a frame of the coffee maker of FIG. 1, according to one aspect of the present disclosure.

FIGS. 3 and 4 are exploded perspective views of FIG. 2 depicting one embodiment of a drip stop mechanism for the brew basket, the drip stop mechanism including a slider mounted on the brew basket and a catch member mounted on the supporting shelf.

FIG. 5 is a partial bottom perspective view of the brew basket of FIG. 2 depicting the slider of the drip stop mechanism in a brew, open position.

FIG. 6 is a partial bottom perspective view of the brew basket of FIG. 2 depicting the slider of the drip stop mechanism in a sealed, closed position.

FIG. 7 is a partial to perspective view of a base of the supporting shelf.

FIG. 8 is a partial cross-sectional view of FIG. 2 depicting the slider in the open position with the catch member engaged to the slider to maintain the slider in the open position.

FIG. 9 is a partial cross-sectional view of FIG. 2 depicting the brew basket partially removed from the supporting shelf with the catch member engaged to the slider to move the slider to the closed position.

FIG. 10 is a partial cross-sectional view of FIG. 2 depicting the slider in the closed position with the catch member disengaged from the slider.

FIG. 11 is a perspective view of a brew basket mounted on a supporting shelf of the coffee maker of FIG. 1, according to another aspect of the present disclosure.

FIG. 12 is a partial cross-sectional view of FIG. 11 depicting another embodiment of a drip stop mechanism for the brew basket, the drip stop mechanism including a slider mounted on the brew basket and a catch member mounted on the supporting shelf.

FIG. 13 is a partial bottom perspective view of the brew basket of FIG. 11 depicting the slider of the drip stop mechanism in the open position.

FIG. 14 is a partial bottom perspective view of the brew basket of FIG. 11 depicting the slider of the drip stop mechanism in the closed position.

FIGS. 15 and 16 depict the catch member of the drip stop mechanism of FIG. 11.

FIG. 17 is a partial cross-sectional view of FIG. 11 depicting the slider in the open position with the catch member engaged to the slider to maintain the slider in the open position.

FIG. 18 is a partial cross-sectional view of FIG. 11 depicting the brew basket partially removed from the supporting shelf with the catch member engaged to the slider to move the slider to the closed position.

FIG. 19 is a partial cross-sectional view of FIG. 11 depicting the slider in the closed position with the catch member disengaged from the slider.

FIG. 20 is a partial bottom perspective view of the brew basket of FIG. 11 depicting the slider of a drip stop mechanism according to another embodiment, the slider in a brew, open position.

FIG. 21 is a partial bottom perspective view of the brew basket depicting the slider of the drip stop mechanism of FIG. 20 in a sealed, closed position.

FIG. 22 is a partial cross-sectional view depicting the slider in the closed position with the drip stop mechanism of FIG. 20.

FIG. 23 is a partial cross-sectional view depicting the slider in the open position with the drip stop mechanism of FIG. 20.

### DETAILED DESCRIPTION

It will be readily understood that the components of the embodiments as generally described herein and illustrated in the figures could be arranged and designed in a wide variety of different configurations. Thus, the following more detailed description of various embodiments, as represented in the figures, is not intended to limit the scope of the present disclosure, but is merely representative of various embodiments.

Spatially relative terms may be used to describe an element and/or feature's relationship to another element(s) and/or feature(s) as, for example, illustrated in the figures. Moreover, any term of degree used herein, such as “substantially”, means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

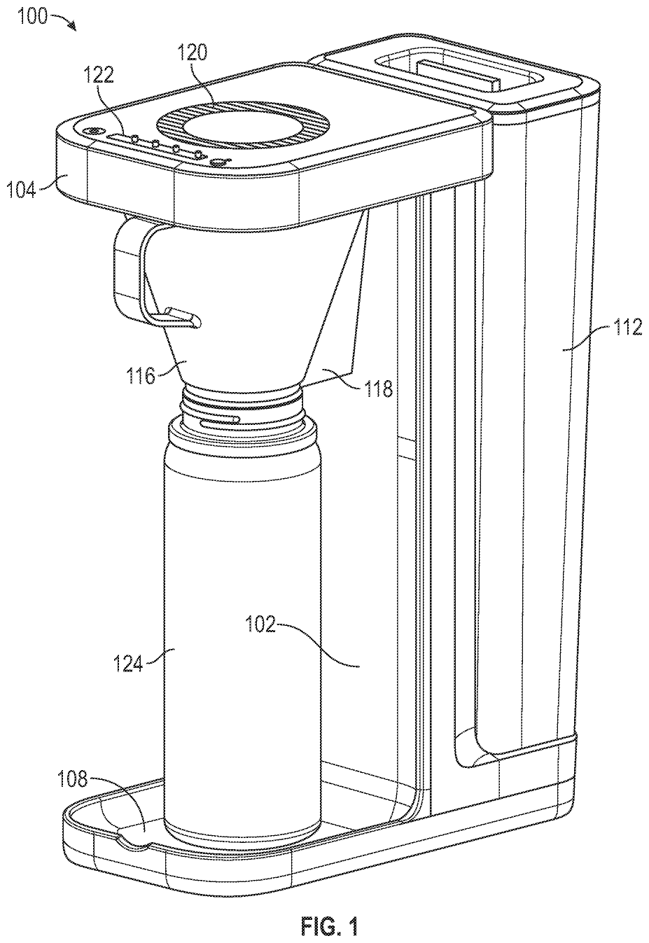

Referring now to the drawings, wherein like numerals refer to like parts throughout the several views, FIG. 1 is perspective views of a coffee maker 100 according to the present disclosure. The coffee maker includes a frame or body 102 having a dispensing head 104 at an upper end portion and a drip catch reservoir 108 at a lower end portion. A drip tray (not shown) can be located in the reservoir. A water tank 112 can be removably coupled to a rear side of the body 102; although, it should be appreciated that the body 102 can be configured to integrally include a water tank. The body 102 is adapted to slidably receive a brew basket 116 beneath the dispensing head 104. By way of example, the body 102 can include a supporting shelf 118, and the brew basket 116 is removably mounted to the supporting shelf. The dispending head 104 can further include steam vents 120 and an operational control 122 having a user-interface. The reservoir 108 is shaped to support a single serve container/cup/vessel 124, such as the illustrated insulated mug; although, it should be appreciated that the reservoir can support a multiple serve carafe.

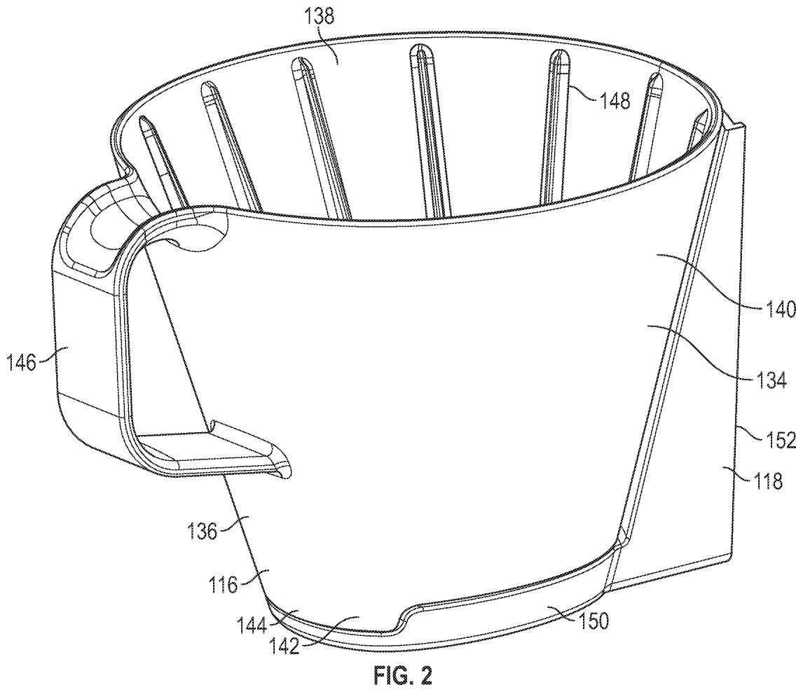

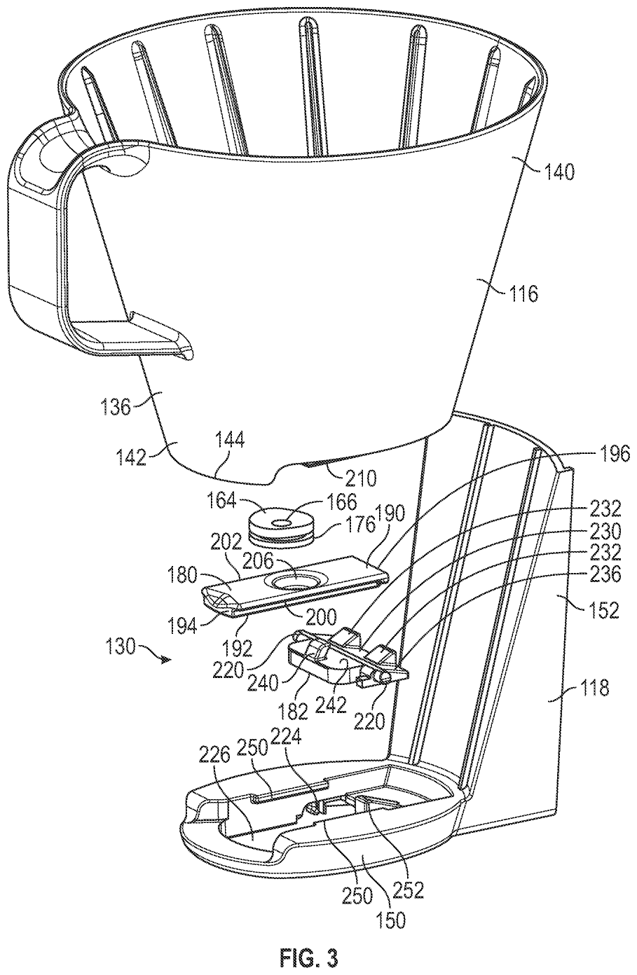

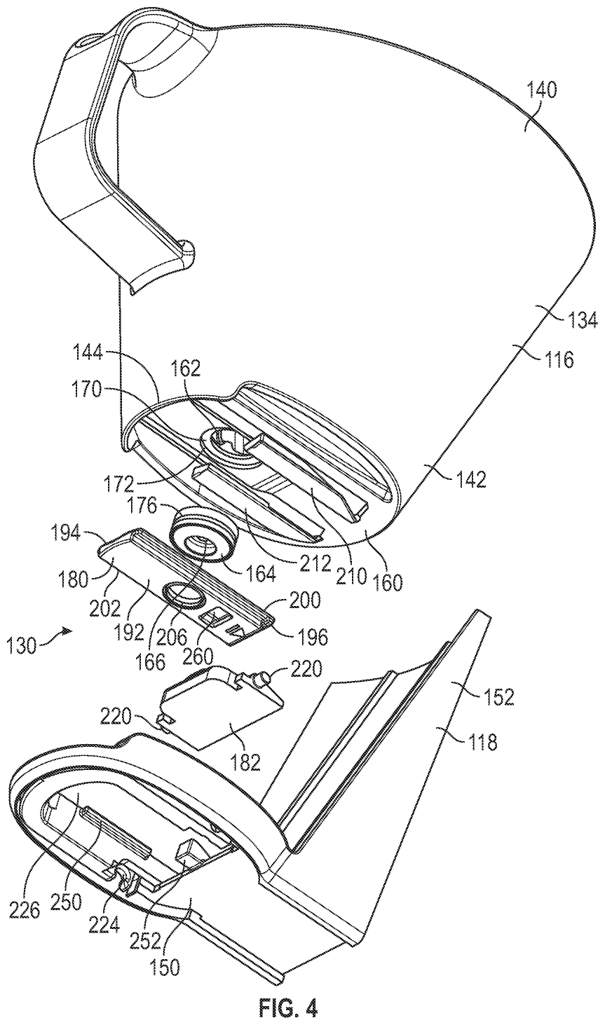

FIG. 2 is a perspective view of the brew basket 116 mounted on the supporting shelf 118, and FIGS. 3 and 4 are exploded perspective views of FIG. 2 depicting one embodiment of a drip stop mechanism 130 for the brew basket 116. The brew basket 116 includes a sidewall 134 with an outer surface 136 and an inner surface 138, an upper portion 140, and a lower portion 142. A lip 144 is located on the lower portion 142. A handle 146 can extend from the outer surface 136 of the sidewall 134. The inner surface 138 can be provided with ribs 148, allowing for ease of removal of a coffee filter after use. The supporting shelf 118 includes a base 150 for slidably receiving and securing the lower portion 142 of the brew basket 116 and an upright member 152 extended from the base and shaped to complementarily receive the sidewall 134 of the brew basket 116. Further depicted, a bottom wall 160 of the lower portion 142 of the brew basket 116 includes a beverage outlet 162 adapted to removably secure a silicone seal 164 having an opening 166 through which brewed coffee flows into the container 124. By way of example, an inner surface portion 170 of the bottom wall 160 that defines the beverage outlet 162 can includes a substantially annular, inwardly extending ledge 172, and the silicone seal 164 can include an annular groove 176 sized to receive the ledge 170. Although, it should be appreciated that alternative manners for securing the seal 164 within the beverage outlet 162 are contemplated.

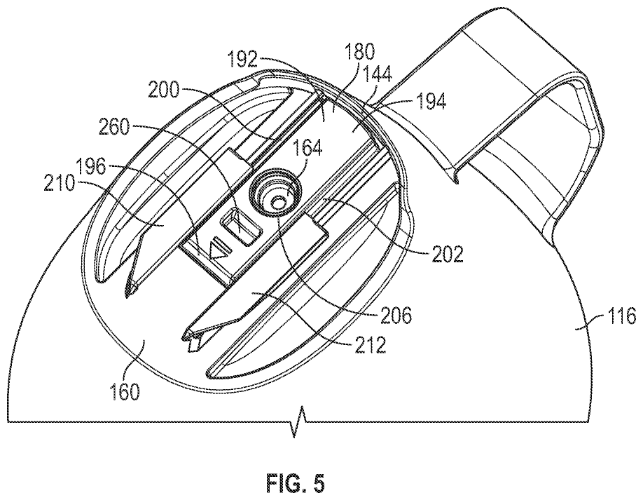

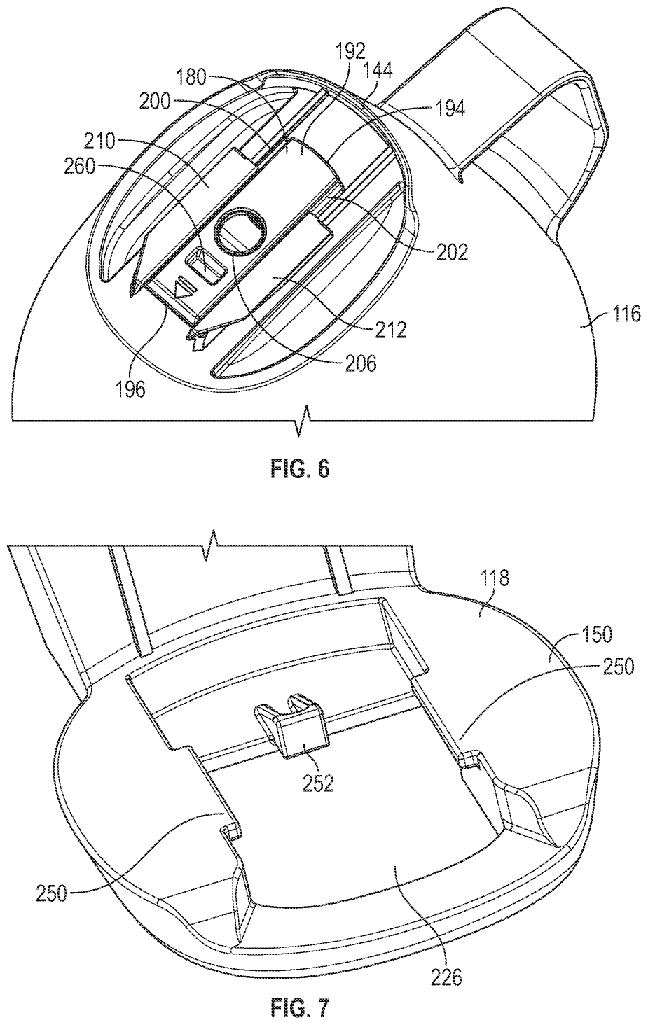

In FIGS. 3 and 4, the exemplary drip stop mechanism 130 includes a slider 180 slidably mounted to an underside of the brew basket bottom wall 160 and a catch member 182 mounted on the base 150 of the supporting shelf 118. The slider 180 is substantially rectangular shaped and generally includes a top wall 190, a bottom wall 192, first and second end walls 194, 196, and first and second sidewalls 200, 202. The slider 180 can include a cutout feature to be aligned with the beverage outlet 162. In the depicted aspect, the cutout feature is a hole 206 extended through the slider 180 between the top and bottom walls 190, 192. As indicated, the seal 164 is secured within the beverage outlet 162; although, it should be appreciated that the seal 164 can be secured within the hole 206 without departing from the features of the present disclosure. To slidably mount the slider 180 to the underside of the bottom wall 160, first and second rails 210, 212 are provided on the bottom wall 160. As shown in FIGS. 5 and 6, the rails 210, 212 and the sidewalls 200, 202 of the slider 180 are configured for slidable engagement therebetween while also maintaining the slider on the brew basket bottom wall 160. By way of example, the sidewalls 200, 202 can be substantially step shaped and each of the rails 210, 212 can include an extension that complementarily mates with the offset defined by the step shaped sidewall. In FIG. 5, the slider 180 is in a brew, open position with the hole 206 formed through the slider aligned or in registry with the beverage outlet 162. The first end wall 194 of the slider is adjacent to, for example abutting, the lip 144 of the brew basket 116. In FIG. 6 the slider 180 is in a sealed, closed position with the hole 206 out of alignment (i.e., offset) from the beverage outlet 162. In this sealed, closed position, the top wall 190 of the slider 180 is sealingly engaged with the seal 164 to seal or close off the beverage opening 162, preventing dripping of coffee from the brew basket 116 as the brew basket is removed from the support shelf 118. As will be described below, the slider 180 includes a first connector having a first configuration and the catch member 182 includes a second connector having a second configuration adapted to engage the first connector, wherein the first and second connectors are engaged to one another in the open position of the slider 180.

With reference back to FIGS. 3 and 4, the catch member 182 of the exemplary drip stop mechanism 130 is pivotally mounted on the base 150 of the supporting shelf 118. For example, the catch member 182 can include pivot pins 220 that are securely received in slots 224 formed in an underside of the base 150; although, alternative manners for mounting the catch member 182 to the base 150 are contemplated. When mounted to the base 150, the catch member 182 is located within an open space 226 defined by the base allowing for selective engagement between the catch member 182 and the slider 180 as the brew basket 116 is moved into and out of the supporting shelf 118. It should be appreciated that the open space 226 allows for the flow of brewed coffee into the container 124 located beneath the base 150. In the depicted aspect, the catch member 182 is defined by a rocker 230 having at least one ramp 232 at one end portion 236 of the catch member (note that a pair of ramps 232 are shown on the rocker), and the second connector in the form of a hook or finger 240 at an opposite end portion 242 of the catch member. The at least one ramp 232 includes a sloped surface extended upwardly and outwardly toward the upright member 152. The hook 240 is canted toward the at least one ramp. According to the present disclosure, the catch member 182 can be biased (for example, by a biasing member (e.g., a spring, not shown) mounted on the catch member and the base) in a counterclockwise direction relative to its pivot axis (as defined by the pivot pins 220) such that when mounted to the base 150 the at least one ramp 232 on the rocker 230 is biased upward in the open space 226 and the hook 240 is biased downward. As will be described below, this allows the hook 240 of the catch member 182 to pivot into engagement with the slider 180 as the brew basket 116 is being moved onto the supporting shelf 118, and also allows the hook 240 to rotate out of the way if the slider 180 is already in the brew, open position when the brew basket 116 is inserted onto the supporting shelf 118.

To secure the brew basket 116 onto the shelf 118 with the slider 180 in the closed position (FIG. 6), the first and second rails 210, 212 on the brew basket are aligned with guide ribs 250 formed on the base 150 that extend into the open space 226 (FIG. 7). As the brew basket 116 is slid onto the shelf 118 toward the upright member 152, the guide rails 210, 212 move along the guide ribs 250 and contact the sloped surfaces of the ramps 232 on the rocker 230 of the catch member 182, which again are biased upward in the open space 226. This contact with the ramps 232 by the guide rails 210, 212 pivots the catch member 182 in a clockwise direction relative to its pivot axis, moving the hook 240 of the catch member toward the slider 180. The supporting shelf 118 includes a stop member or rib 252 on the base (FIG. 7) which is adapted to engage the slider 180 as the brew basket 116 is being mounted onto the supporting self. Therefore, continued movement of the brew basket on the base 150 to a fully seated position on the supporting shelf 118 causes the second end wall 196 of the slider 180 to contacts the stop member 252 on the base. This contact allows for movement of the brew basket 116 relative to the slider 180 to the fully seated position on the base 150. And as the brew basket 116 moves relative to the slider 180 abutted against the stop member 252, the slider 180 moves on the brew basket bottom wall 160 from the closed position toward the open position (FIG. 5) as the brew basket 116 is being fully seated. The bottom wall 192 of the slider 180 includes the first connector in the form of a cavity or cutout 260, and in the open position of the slider 180 the hook 240 of the catch member 182, which is moved toward the slider 180 via engagement of the ramps 232 by the guide rails 210, 212, is received in the cavity 260 to maintain the slider in the open position.

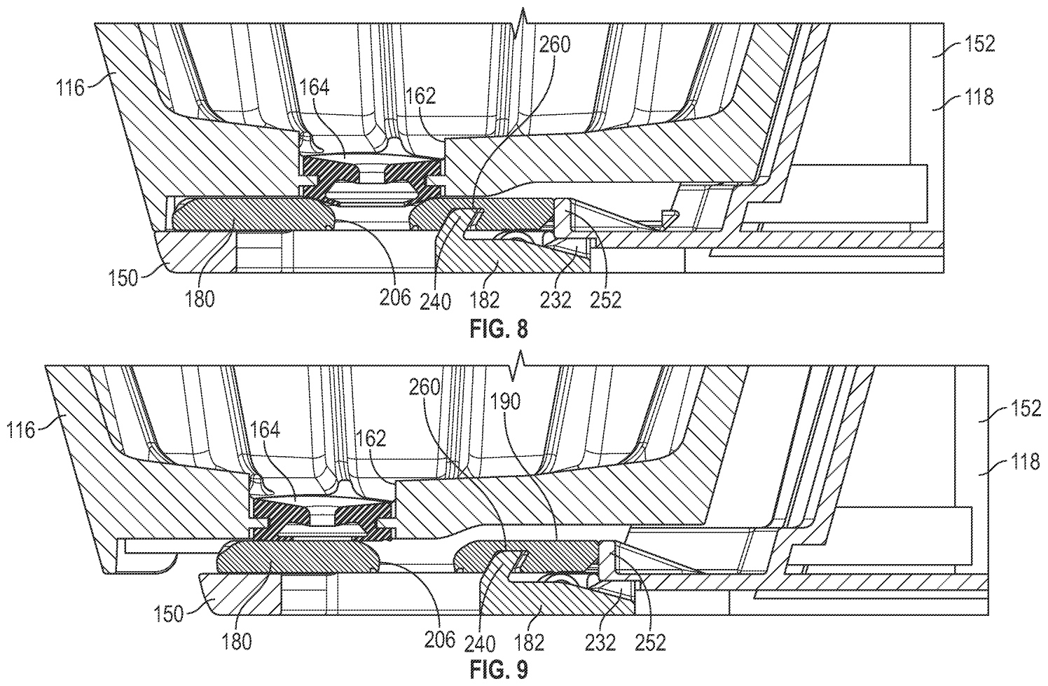

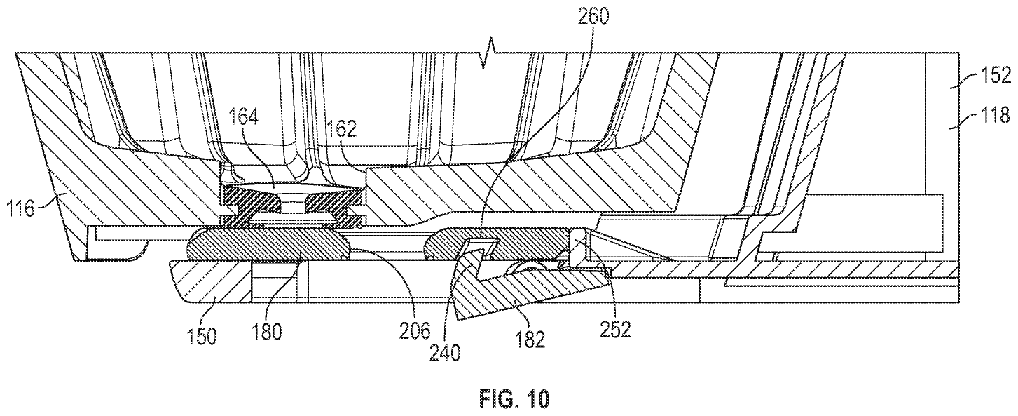

With reference to FIG. 8, after the brew basket 116 is inserted onto the base 150 of the supporting shelf 118 (via the guide rails 210, 212), the slider 180 is moved toward the open position allowing the hook 240 to project into the cavity 260 formed in the slider 180. Note that with the slider 180 in the open position the catch member 182 can be in a biased, loaded position because of the spring (not shown) biasing the catch member 182 in the counter clockwise direction relative to its pivot axis. In FIG. 9, it should be appreciated that the engagement of the slider 180 via the catch member 182 is temporarily maintained as the brew basket 116 is being pulled outward off the base 150 of the supporting shelf 118. By holding the slider 180 in place (for a predetermined amount of outward travel of the brew basket 116) via the hook 240 of the catch member 182 positioned in the cavity 260, the slider 180 is moved toward the sealed, closed position while the brew basket 116 is still mounted to the base 150. In the closed position, the top wall 190 of the slider engages the seal 164 to close off the beverage outlet 162. As depicted in FIG. 9, the ramps 232 of the rocker 230 are still depressed by the guide rails 210, 212 on the underside of the brew basket 116, which again pivots the hook 240 into the slider 180. In FIG. 10, the brew basket 116 is slid further outward on the base 150 of the supporting shelf 118. This moves the guide rails 210, 212 off the ramps 232 allowing the rocker 230 and hook 240 (i.e., the catch member 182) to rotate back to its original position. The hook 240 is removed from the slider cavity 260, releasing the slider 180 and allowing the brew basket 116 to be completely removed from the supporting shelf 118 with the slider in the closed position. As described, the first connector of the slider 180 is the cavity 260, and the second connector of the catch member 182 is the hook 240. However, it should be appreciated that the first connector can be the hook and the second connector can be the cavity without departing from the present disclosure.

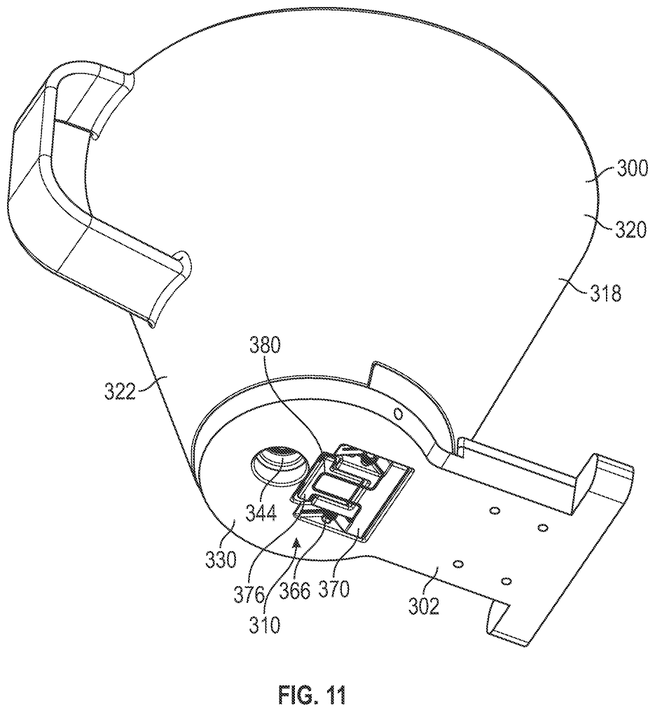

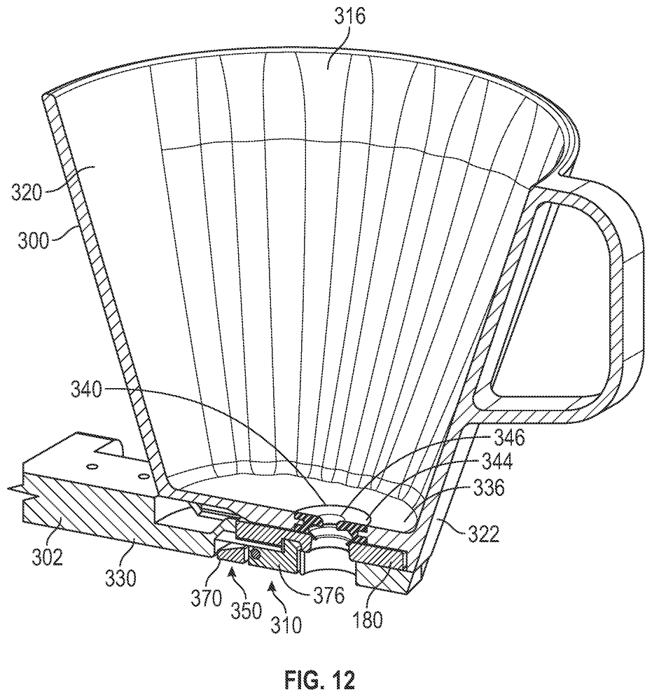

FIGS. 11-19 depict a brew basket 300 and supporting shelf 302 including another embodiment of a drip stop mechanism 310 for the coffer maker 100. Similar to the brew basket 116, the brew basket 300 includes a sidewall 314 with an outer surface 316 and an inner surface 318, an upper portion 320, and a lower portion 322. The supporting shelf 302 includes a base 330 for slidably receiving and securing the lower portion 322 of the brew basket 300. Further depicted, a bottom wall 336 of the lower portion 332 of the brew basket 300 includes a beverage outlet 340 adapted to secure a silicone seal 344 having an opening 346, which can be similar to the seal 164.

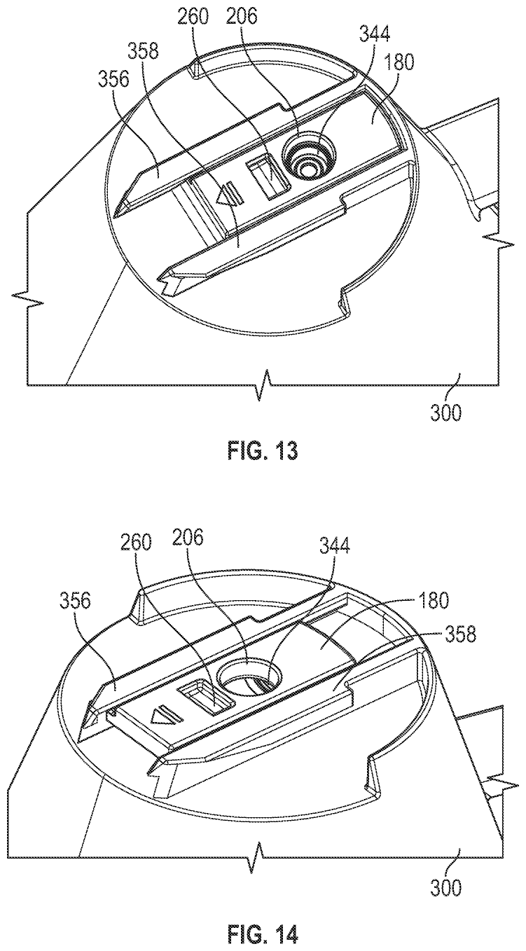

The drip stop mechanism 310 includes the slider 180 described above slidably mounted to an underside of the brew basket bottom wall and a catch member 350 mounted on the base 330 of the shelf 302 that supports the brew basket 300. To slidably mount the slider 180 to the underside of the bottom wall 336, first and second rails 356, 358 are provided on the bottom wall 336 for engaging the sidewalls of the slider 180 in a manner similarly described. In FIG. 13 the slider 180 is in a brew, open position with the hole 206 formed through the slider aligned with the beverage outlet 340. In FIG. 14 the slider 180 is in a sealed, closed position with the hole 206 out of alignment (i.e., offset) from the beverage outlet 340. In this sealed, closed position, the top wall of the slider 180 is sealingly engaged with the seal 344 to close off the beverage outlet 340.

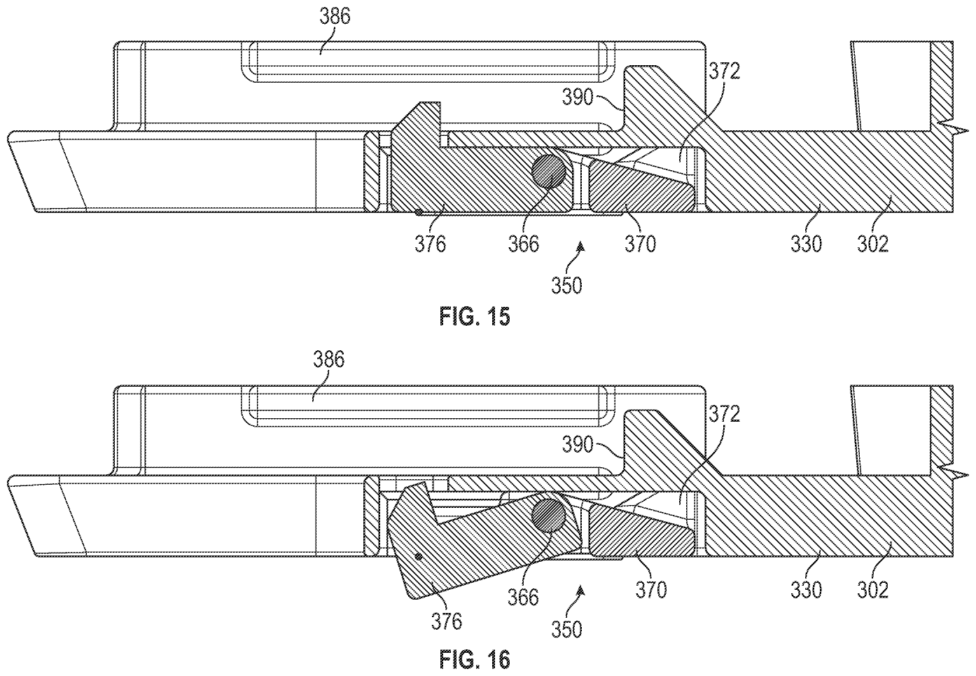

With reference to FIGS. 15 and 16, the catch member 350 is pivotally mounted within a recessed portion in the base 330 of the supporting shelf 302, by, for example, a pivot pin 366 securely received in slots formed in an underside of the base 330. In the depicted aspect, the catch member 350 is defined by a rocker 370 having ramps 372, and a hook 376. The rocker 370 and hook 372 of the catch member 350 are separate components connected to one another by the pivot pin 366, thereby allowing for individual movement of the hook relative to the rocker. However, it should be appreciated that the catch member 350 can be a unitary component similar to catch member 182. The rocker 370 and hook 372 of the catch member 350 can be biased by a biasing member (e.g., a spring 380 (FIG. 11)), where the ramps 372 of the rocker are normally pivoted upwardly relative to the hook 372 for engagement with the rails 356, 358 on the brew basket. This biasing of the catch member 350 allows the catch member to move into engagement with the slider 180 as the brew basket 300 is being moved onto the supporting shelf 302, and also allows the hook 376 to rotate out of the way relative to the rocker 370 if the slider 180 is already in the brew, open position when the brew basket 300 is inserted onto the supporting shelf (FIG. 16).

To secure the brew basket 300 onto the shelf 302 with the slider 180 in the closed position (FIG. 14), the rails 356, 358 on the brew basket are aligned with rails on the base 330 (only rail 386 is shown). As the brew basket 300 is slid onto the shelf 302, the brew basket rails 356, 358 move along the base rails and contact the ramps 372 on the rocker 370 of the catch member 350. This contact by the brew basket rails 356, 358 pivots the catch member 350 in a clockwise direction relative to its pivot axis, moving the hook 376 of the catch member against the bottom wall the slider 180. Because the hook 376 is movably relative to the rocker 370, the hook can be slightly rotated in a counterclockwise relative to its pivot axis via contact with the slider 180. Continued movement of the brew basket 300 causes the slider 180 in the closed position to contact a stop member or rib 390 on the base 330, which, in turn, allows the slider to move toward the open position (FIG. 13) as the brew basket 300 is fully seated on the supporting shelf 302. In the open position of the slider 180 the hook 376 is received in the cavity 260 of the slider 180 to maintain the slider in the open position.

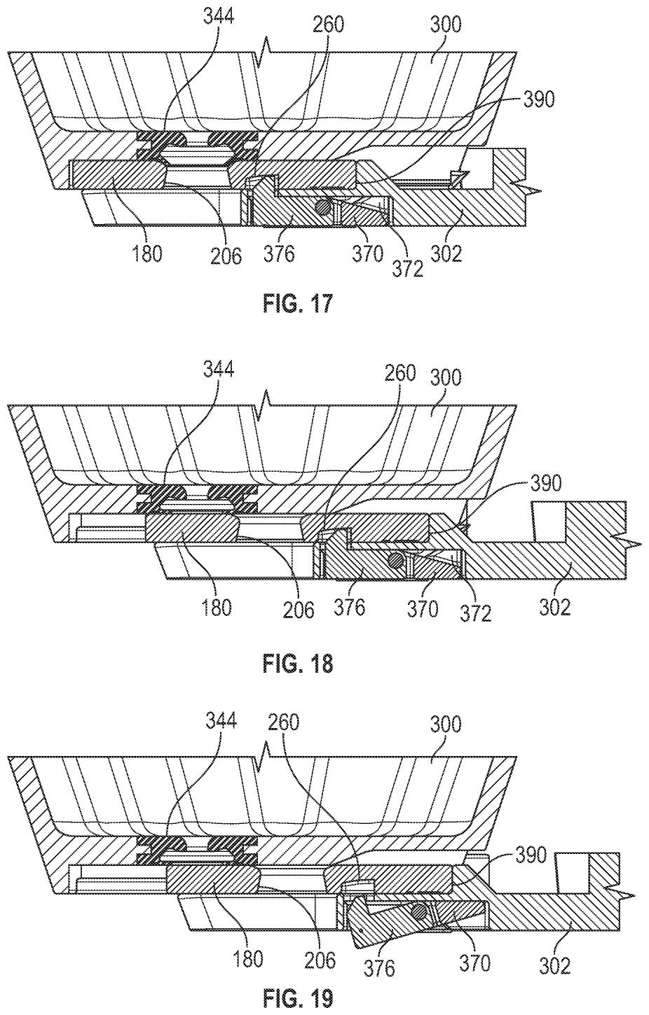

Therefore, contact of front edges of the brew basket rails 356, 358 with the ramps 372 (via sliding of the brew basket 300 onto the shelf 302) causes the rocker 370 and the hook 376 to move into a loaded position against the bias of the spring 380. The rails 356, 358 hold the ramps 372 down after being inserted. With reference to FIG. 17, after the brew basket 300 is inserted onto the shelf 302, the slider 180 is moved toward the brew position allowing the hook 376 to project into the cavity 260 formed in the slider 180. This engagement of the hook with the slider maintains the slider in the brew position. Note that with the slider in the brew position the rocker 370 and hook 376 are in the loaded position. In FIG. 18, it should be appreciated that the engagement of the slider 180 via the catch member 350 is maintained as the brew basket 300 is being pulled outward off the shelf 302. By holding the slider 180 in place via the hook 376 positioned in the cavity 260, the slider 180 is moved to the sealed, closed position. In FIG. 18, the ramps 372 of the rocker 370 are still depressed by the brew basket rails 356, 358 on the underside of the brew basket 116. In FIG. 19, the brew basket 300 is slid further outward on the shelf 302. This moves the brew basket rails 356, 358 off the ramps 376 allowing the rocker 370 and hook 376 to rotate back to their original position. The hook 376 is removed from the slider cavity 260, releasing the slider and allowing the brew basket to be completely removed from the shelf.

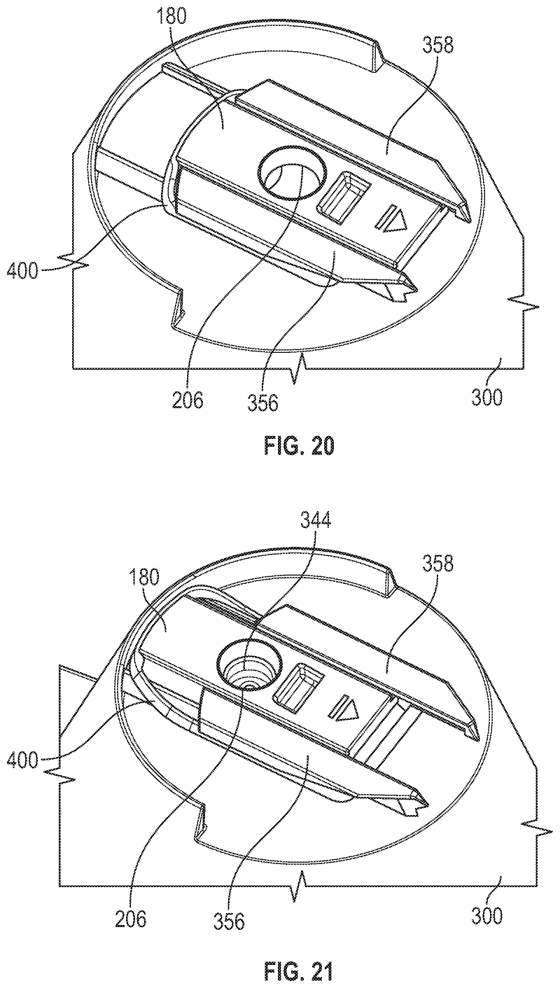

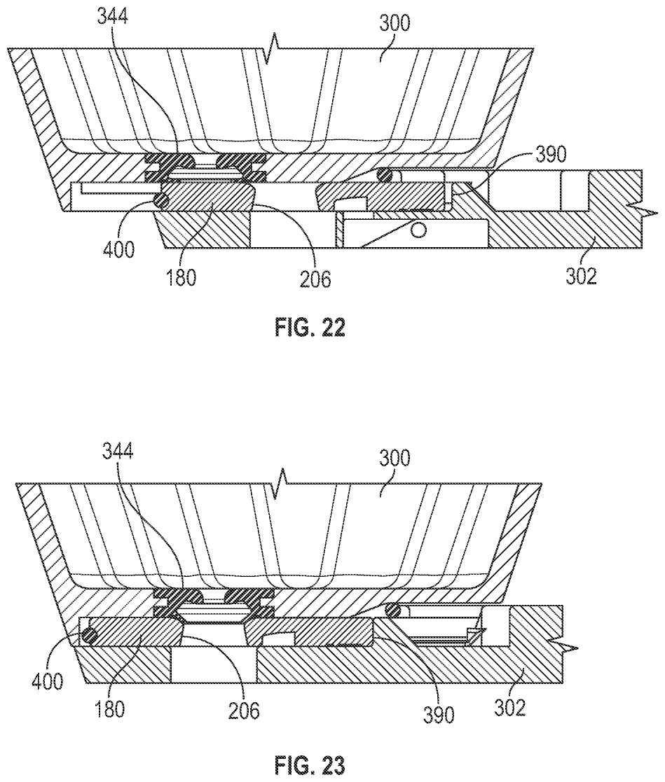

FIGS. 20-23 depict an alternative arrangement for biasing the slider 180 to the sealed, closed position. A biasing member, such as the depicted elastic (i.e., silicone) band 400, is secured to brew basket rails 356, 358 on the underside of the bottom wall of the brew basket 300 and is looped around the end wall of the slider 180. When the brew basket 300 is removed from the supporting shelf 302, the band 400 maintains the slider 180 in the sealed, closed position. When the brew basket 300 is being inserted onto the shelf 302, the rib 390 provided on the shelf 302 pushes the slider 180 toward the brew position, stretching the band 400. As the brew basket 300 is being removed from the shelf 302, the band 400 moves the slider 180 back toward the sealed, closed position. It should be appreciated that alternative biasing members for use with the slider 180 are contemplated, for example, a spring return, such as a compression spring, a tension spring and/or a torsion spring, can be mounted on the brew basket and connected to the slider 180, the return spring biasing the slider toward the closed position.

In each of the aspects of the present disclosure described above, the supporting shelf 118, 302 is provided beneath the dispensing head 104 where the brew basket 116, 300 is mounted atop. However, it should be appreciated that the supporting shelf 118, 302 can be provided with the dispensing head 104, where the brew basket 116, 300 is connected to the dispensing head 104. With this alternative location of the supporting shelf, the frame or body 102 of the coffee maker 100 would include another supporting shelf beneath the dispending head for mounting of the catch member 182, 350. The function of the catch member 182, 350 on the another supporting shelf would be the same as described above.

It will be appreciated that various of the above-disclosed embodiments and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the present disclosure and the following claims.

1. A coffee maker comprising:
a frame;
a brew basket slidably mounted to the frame, the brew basket including a beverage outlet; and
a drip stop mechanism operatively associated with the brew basket, the drip stop mechanism includes a slider slidably mounted to an underside of the brew basket, wherein the slider is adapted to move from a sealed, closed position where the beverage outlet is closed by the slider toward a brew, open position where the beverage outlet is open as the brew basket is being mounted on the frame, and the slider is adapted to move from the open position toward the closed position as the brew basket is removed from the frame.

2. The coffee maker of claim 1, wherein the drip stop mechanism includes a catch member mounted on the frame, and with the brew basket mounted on the frame and slider in the open position the catch member is engaged to the slider.

3. The coffee maker of claim 2, wherein catch member is adapted to move out of engagement with the slider as the brew basket is being removed from the frame.

4. The coffee maker of claim 2, wherein the slider includes a first connector having a first configuration and the catch member includes a second connector having a second configuration adapted to engage the first connector, wherein the first and second connectors are engaged to one another in the open position of the slider.

5. The coffee maker of claim 4, wherein first connector of the slider is one of a hook and a cavity sized to receive the hook, and the second connector of the catch member is the other of the cavity and the hook.

6. The coffee maker of claim 4, wherein the catch member is adapted to move the second connector out of engagement with the first connector of the slider as the brew basket is being removed from the frame.

7. The coffee maker of claim 2, wherein the catch member includes a ramp for contact with the brew basket being mounted on the frame, wherein contact of the brew basket with the ramp moves the catch member into engagement with the slider.

8. The coffee maker of claim 7, wherein the brew basket includes guide rails for slidably mounting to the frame, the guide rails adapted to contact the ramp as the brew basket is being mounted on the frame.

9. The coffee maker of claim 2, where the catch member is biased by a biasing member in a direction away from engagement with the slider.

10. The coffee maker of claim 2, wherein the catch member is adapted to temporarily maintain the slider in the open position as the brew basket is being removed from the frame, wherein movement of the brew basket relative to the slider maintained by the catch member moves the slider toward the closed position.

11. The coffee maker of claim 1, wherein a seal is secured in the beverage outlet, and in the closed position the slider sealingly engages the seal to close off the beverage outlet.

12. The coffee maker of claim 1, wherein the frame includes a stop member adapted to engage the slider as the brew basket is being mounted onto the frame, allowing for movement of the brew basket relative to the slider to a fully mounted position on the frame.

13. The coffee maker of claim 1, wherein the drip stop mechanism includes a biasing member mounted to the underside of the brew basket and connected to the slider, the biasing member biasing the slider toward the closed position.

14. A drip stop mechanism for a brew basket of a coffee maker, the coffee maker includes a frame for the brew basket, the drip stop mechanism comprising:
a slider slidably mounted to an underside of the brew basket, the slider adapted to slide along the underside of the brew basket between a brew, open position with the brew basket mounted on the frame and a sealed, closed position with the brew basket removed from the frame; and
a catch member pivotably mounted to the frame, the catch member adapted to engage the slider as the brew basket is being mounted on the frame.

15. The drip stop mechanism of claim 14, wherein the catch member is adapted to temporarily maintain the slider in the open position as the brew basket is being removed from the frame, wherein movement of the brew basket relative to the slider maintained by the catch member slides the slider toward the closed position, and the catch member is adapted to pivot way the slider in the closed position.

16. The drip stop mechanism of claim 14, wherein the catch member includes a hook for engaging the slider in the open position.

17. The drip stop mechanism of claim 14, wherein the catch member includes a ramp for contact with the brew basket being mounted on the frame, wherein the catch member is adapted such that contact of the brew basket with the ramp pivots the catch member into engagement with the slider.

18. The drip stop mechanism of claim 14, wherein the catch member is biased by a biasing member in a direction away from engagement with the slider.
